(19) United States
(12) Patent Application Publication
(10) Pub. No.: US 2021/0284491 A1
(43) Pub. Date: Sep. 16, 2021

(54) CONTROL SYSTEM AND METHOD FOR LOCATION OF A ROBOT PASSENGER WHEN WAITING FOR AN ELEVATOR

(71) Applicant: Otis Elevator Company, Farmington, CT (US)

(72) Inventors: Yu Zhang, Shanghai (CN); Shenhong Wang, Shanghai (CN)

(21) Appl. No.: 17/095,425

(22) Filed: Nov. 11, 2020

(30) Foreign Application Priority Data
Mar. 16, 2020 (CN) 202010181023.2

(51) Int. Cl. B66B 1/34; B66B 1/28; B66B 1/36; B66B 11/02

(52) U.S. Cl. CPC B66B 1/3461; B66B 1/28; B66B 2201/405; B66B 11/0233; B66B 1/36

(57) ABSTRACT

A control system and method for elevator-waiting position of a robotic passenger. A control system for elevator-waiting position of a robotic passenger includes: a detection device configured to detect whether a first-choice elevator-waiting position has been occupied; and a position allocation unit configured to if the first-choice elevator-waiting position is not occupied, determine the first-choice elevator-waiting position as a target elevator-waiting position; and if the first-choice elevator-waiting position has been occupied, determine a candidate elevator-waiting position as the target elevator-waiting position or issue a prompt.

### FOREIGN PRIORITY

This application claims priority to Chinese Patent Application No. 202010181023.2, filed Mar. 16, 2020, and all the benefits accruing therefrom under 35 U.S.C. § 119, the contents of which in its entirety are herein incorporated by reference.

### FIELD OF THE INVENTION

The present disclosure relates to the field of elevators, and more particularly, the present disclosure relates to a control system and method for elevator-waiting position of a robotic passenger in a building.

### BACKGROUND OF THE INVENTION

With the rapid development in the fields of robotics, mobile communications, and artificial intelligence, movable robotic passengers have gradually emerged in people's daily lives. There are some robotic passengers that are moving in a building, such as robots that perform food delivery services in hotels, and they need to take the elevator when performing tasks. This type of robot is pre-set with a fixed elevator-waiting position. If this position is occupied, it is possible that the robotic passenger will become sluggish and spin around, which will hinder other passengers who will take the elevator.

### SUMMARY OF THE INVENTION

An object of the present disclosure is to solve or at least alleviate the problems existing in the related art.

In one aspect, a control system for elevator-waiting position of a robotic passenger is provided, which includes: a detection device configured to detect whether a first-choice elevator-waiting position has been occupied; and a position allocation unit configured to: if the first-choice elevator-waiting position is not occupied, determine the first-choice elevator-waiting position as a target elevator-waiting position; and if the first-choice elevator-waiting position has been occupied, determine a candidate elevator-waiting position as the target elevator-waiting position or issue a prompt.

Optionally, the position allocation unit is configured to issue a voice prompt and wait for a specific time if the first-choice elevator-waiting position has been occupied.

Optionally, after the specific time, the detection device re-detects whether the first-choice elevator-waiting position has been occupied; if the first-choice elevator-waiting position is not occupied, the first-choice elevator-waiting position is determined as the target elevator-waiting position, and if the first-choice elevator-waiting position is still occupied, the candidate elevator-waiting position is determined as the target elevator-waiting position.

Optionally, the detection device includes a lidar sensor and/or a camera sensor.

Optionally, the control system for elevator-waiting position of the robotic passenger is integrated in the robotic passenger, and the robotic passenger includes: a robotic passenger body; a mobile device which drives the robotic passenger body to move; a position determination device configured to detect the position of the robotic passenger in a building; and a communication device configured to communicate with an elevator control device.

Optionally, the position allocation unit includes a memory in which a map is stored, and the map includes a surrounding scene of at least one elevator-waiting hall, and a first-choice elevator-waiting position and a candidate elevator-waiting position in the at least one elevator-waiting hall.

Optionally, the control system for elevator-waiting position of the robotic passenger is integrated in an elevator control system, and the control system for elevator-waiting position of the robotic passenger further includes a device that exposes the target elevator-waiting position.

Optionally, said exposing the target elevator-waiting position includes changing the illumination and/or color of the target elevator-waiting position.

Optionally, the control system for elevator-waiting position of the robotic passenger includes a projection lamp, from which the target elevator-waiting position is projected.

Optionally, the control system for elevator-waiting position of the robotic passenger includes at least one ground lamp embedded in the floor, from which the target elevator-waiting position is illuminated.

Optionally, said exposing the target elevator-waiting position includes exposing a text or logo indication at the target elevator-waiting position.

In another aspect, a control method for elevator-waiting position of a robotic passenger is provided, which includes: detecting whether a first-choice elevator-waiting position has been occupied; if the first-choice elevator-waiting position is not occupied, determining the first-choice elevator-waiting position as a target elevator-waiting position; and if the first-choice elevator-waiting position has been occupied, determining a candidate elevator-waiting position as the target elevator-waiting position or issuing a prompt.

Optionally, in the method, a voice prompt is issued and a specific time is waited for if the first-choice elevator-waiting position has been occupied.

Optionally, after the specific time, it is re-detected whether the first-choice elevator-waiting position has been occupied; if the first-choice elevator-waiting position is not occupied, the first-choice elevator-waiting position is determined as the target elevator-waiting position, and if the first-choice elevator-waiting position is still occupied, the candidate elevator-waiting position is determined as the target elevator-waiting position.

Optionally, in the method, the detection device includes a lidar sensor and/or a camera sensor.

Optionally, in the method, the method further includes controlling the robotic passenger to move to the target elevator-waiting position.

Optionally, in the method, the method further includes exposing the target elevator-waiting position.

Optionally, in the method, said exposing the target elevator-waiting position includes changing the illumination and/or color of the target elevator-waiting position.

Optionally, in the method, said exposing the target elevator-waiting position includes using a projection lamp to project the target elevator-waiting position.

Optionally, in the method, said exposing the target elevator-waiting position includes illuminating a lamp embedded in the floor at the at least one elevator-waiting position.

Optionally, in the method, said exposing the target elevator-waiting position includes exposing a text or logo indication at the target elevator-waiting position.

Optionally, the method further includes assigning a designated elevator based on one or more of robotic passenger information, elevator system information, and building information, and determining the first-choice elevator-waiting position or candidate elevator-waiting position corresponding to the designated elevator as the target elevator-waiting position.

The device and method according to the present disclosure achieve a better interaction between the robotic passenger and human when the robotic passenger is taking the elevator.

### BRIEF DESCRIPTION OF THE DRAWINGS

The contents of the present disclosure will become easier to understand with reference to the accompanying drawings. It can be easily understood by those skilled in the art that the drawings are merely used for illustration, and are not intended to limit the scope of protection of the present disclosure. In addition, like parts are denoted by like numerals in the drawings, wherein:

FIG. 1 shows a schematic view of an elevator system to which a control system for elevator-waiting position of a robotic passenger according to an embodiment of the present disclosure is applied;

FIG. 2 shows a flowchart of a control method for elevator-waiting position of a robotic passenger according to an embodiment of the present disclosure;

FIG. 3 shows a flowchart of a control method for elevator-waiting position of a robotic passenger according to another embodiment of the present disclosure; and

FIG. 4 shows a flowchart of a control method for elevator-waiting position of a robotic passenger according to another embodiment of the present disclosure.

### DETAILED DESCRIPTION OF THE EMBODIMENT(S) OF THE INVENTION

The robotic passengers in the following embodiments of the present disclosure may be various types of robots that can take an elevator, such as take-out robots, food delivery robots, courier robots, etc. The robotic passengers may also be transport vehicles that are autonomously movable in a controlled manner. It will be understood that the specific type, structure and/or use of the robotic passenger may be diverse, and are not limited by the following embodiments of the present disclosure.

The present disclosure provides a control system for elevator-waiting position of a robotic passenger, which includes: a detection device configured to detect whether a first-choice elevator-waiting position has been occupied; and a position allocation unit configured to: if the first-choice elevator-waiting position is not occupied, determine the first-choice elevator-waiting position as a target elevator-waiting position; and if the first-choice elevator-waiting position has been occupied, determine a candidate elevator-waiting position as the target elevator-waiting position or issue a prompt.

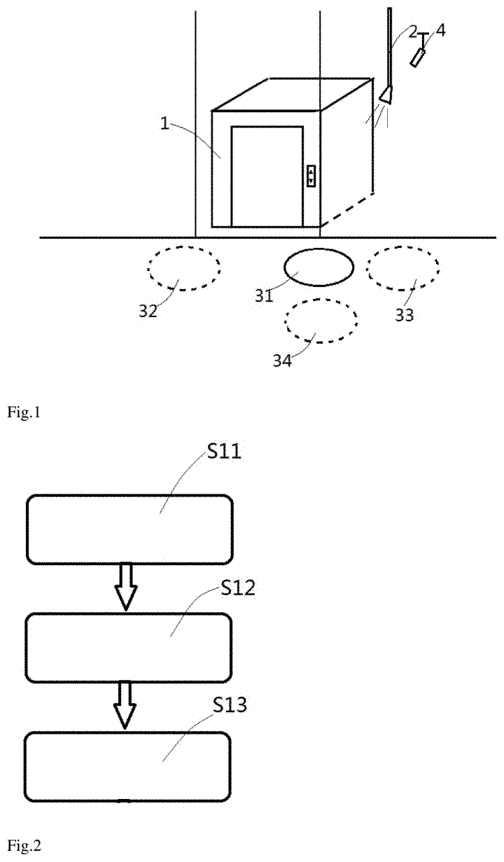

Referring to FIG. 1, an elevator system to which a control system for elevator-waiting position of a robotic passenger according to an embodiment of the present disclosure is applied is illustrated. The elevator system includes: at least one elevator 1 (only one elevator is shown in the figure), such as one, two or more elevators; an elevator control device (not shown) that controls the operation of the at least one elevator 1; and at least one elevator-waiting position 31, 32, 33 and 34 in at least one elevator-waiting hall in the building; wherein the elevator control device may be integrated with the control system for elevator-waiting position of the robotic passenger according to the present disclosure. For example, the detection device may be implemented as a camera device 4 arranged in the elevator-waiting hall, and the position allocation unit may be integrated in a controller of the elevator control device (e.g., a processor-based controller). The elevator control device is configured to, upon receiving an elevator-taking request signal sent from the robotic passenger, assign the elevator that executes the elevator-taking request, and the control system for elevator-waiting position of the robotic passenger determines at least one elevator-waiting position 31, 32, 33 and 34 corresponding to the assigned elevator as the target elevator-waiting position, and optionally notifies the robotic passenger of the target elevator-waiting position and/or exposes the target elevator-waiting position. In various places of the present disclosure, exposing a certain position refers to changing the position from an ordinary state to a more significant and more perceptible state, for example, exposing a certain position by changing the illumination, the color and the like. In the present disclosure, the elevator-waiting hall may refer to the elevator-waiting halls on various floors, such as the lobby on the ground floor or the elevator-waiting hall on any other floor. The at least one elevator-waiting position includes a first-choice elevator-waiting position 31 and candidate elevator-waiting positions 32, 33 and 34. The determination as the target elevator-waiting position specifically includes: detecting whether the first-choice elevator-waiting position 31 is occupied by using the detection device; and the position allocation unit is configured to: if the first-choice elevator-waiting position 31 is not occupied, determine the first-choice elevator-waiting position 31 as the target elevator-waiting position; and if the first-choice elevator-waiting position 31 has been occupied, determine at least one (for example, an unoccupied one) of the candidate elevator-waiting positions 32, 33 and 34 as the target elevator-waiting position or issue a prompt.

In some embodiments, the illumination and/or the color may be changed to expose at least one elevator-waiting position. In some embodiments, as shown in FIG. 1, the elevator system may include a projection device 2 that can project a light corresponding to the first-choice elevator-waiting position 31; optionally, the light may include a text prompt, such as a projection of words “elevator-waiting position of robotic passenger”, or the light may include a pattern prompt, such as a pattern of the robotic passenger and the like, or a combination of the two may be used. In some other embodiments, the elevator system may include lamps embedded under the first-choice elevator-waiting position 31 and the optional candidate elevator-waiting positions 32, 33 and 34, which may be illuminated in response to the corresponding position being determined as the target elevator-waiting position. Moreover, the texts or patterns on transparent lampshades on the ground and of the first-choice elevator-waiting position 31 and the optional candidate elevator-waiting positions 32, 33 and 34 may for example be exposed. With such an arrangement, when there is no request to take the elevator from the robotic passenger, other passengers will not notice or cannot easily notice the at least one elevator-waiting position 31, 32, 33 and 34 for the robotic passenger to take the elevator, and when the robotic passenger needs to take the elevator, other passengers can clearly know about the elevator-waiting position of the robotic passenger, and make room for this position.

In the illustrated embodiment, the first-choice elevator-waiting position 31 is located on the right side of the elevator landing door. In an alternative embodiment, the first-choice elevator-waiting position 31 may be set at any suitable position. In some embodiments, the elevator system may include a plurality of candidate positions 32, 33 and 34 for the robotic passenger to wait for the elevator, and the elevator control device may be further configured to, after receiving the elevator-taking request signal sent from the robotic passenger, expose at least one of the candidate elevator-waiting positions 32, 33 and 34. For example, the elevator system can detect whether someone has occupied the first-choice elevator-waiting position 31 through at least one camera device arranged in the elevator-waiting hall. In the case of receiving the elevator-taking request sent by the robotic passenger and detecting that the first-choice elevator-waiting position is occupied, the elevator system may detect whether the plurality of candidate elevator-waiting positions 32, 33 and 34 are occupied. If one of the candidate elevator-waiting positions such as the candidate elevator-waiting position 34 is not occupied, this candidate elevator-waiting position may be determined as the target elevator-waiting position and exposed, and/or the candidate elevator-waiting position 34 may be notified to the robotic passenger so that the robotic passenger directly moves to the candidate elevator-waiting position 34 to wait for the elevator. In addition, when there are a plurality of robotic passengers simultaneously issuing the elevator-taking request, the elevator control device may, for example, expose the first-choice elevator-waiting position and the candidate elevator-waiting positions at the same time, send the first-choice elevator-waiting position information to the first robotic passenger, send the first candidate elevator-waiting position to the second robotic passenger, and so on, thereby coordinating the elevator-waiting positions of individual robotic passengers.

In some embodiments, the elevator system may include a plurality of elevators, and each elevator may include at least one corresponding elevator-waiting position for the robotic passenger to wait for the elevator. The elevator control device is configured to, upon receiving the elevator-taking request signal sent by the robotic passenger, assign a designated elevator to execute the elevator-taking request of the robotic passenger based on one or more of robotic passenger information, elevator system information and building information, and the elevator control device exposes at least one elevator-waiting position corresponding to the assigned elevator and notifies the robotic passenger. After receiving the notification, the robotic passenger may directly move to at least one elevator-waiting position corresponding to the assigned elevator to wait for the elevator. With such an arrangement, only the elevator-waiting position in front of the elevator that is assigned to execute the elevator-taking request of the robotic passenger (i.e., the determined target elevator-waiting position) is exposed, without affecting passengers waiting for other elevators. In some embodiments, the robotic passenger information may include: the position of the robotic passenger and the moving speed of the robotic passenger, etc.; the elevator system information may include: the position, operating status, received elevator-calling instruction and elevator load of each of the elevators, and the like. The elevator load is the passengers in the current elevator and their destination floor; the building information includes the density of people in various areas of the building and the closing or opening of an access control system.

In addition, the elevator control device may also consider building-related information when assigning a designated elevator to execute the elevator-taking request of the robotic passenger, such as the density of people in the movement path of the robotic passenger, the density of people in the floor, the density of people in the elevator-waiting hall, and the like. When elevator-taking request signals of a plurality of robotic passengers are received, the elevator control device may coordinate and assign the elevators that execute the elevator-taking request of each of the robotic passengers based on the above information. In some embodiments, the elevator system may decide whether to assign an elevator to the robotic passenger or when to assign the elevator to the robotic passenger, based on the current elevator load. For example, when the elevator load is heavy, the robotic passenger may be made wait at the waiting position to avoid affecting passengers who will take the elevator. In some embodiments, if the robotic passenger is farther away from the elevator in the elevator system, the assignment of the elevator may be delayed and the elevator is assigned only after the robotic passenger become closer. In any embodiment in which the assignment of the elevator is delayed, exposing the target elevator-waiting position may be performed after the elevator is assigned. In addition, in the device according to the present disclosure, for example, the floor lamp, projection lamp, camera device and the like in at least one elevator-waiting position may be arranged on a certain floor, such as the ground floor, or these devices may also be arranged on each floor.

In addition, the control system for elevator-waiting position of the robotic passenger according to the embodiment of the present disclosure may also be used as a part of the robotic passenger, and may be applied separately or in combination with the elevator system according to the present disclosure to realize a better interaction between the human and robotic passengers in the process of waiting for the elevator. The robotic passenger may include: a robotic passenger body; a mobile device which drives the robotic passenger body to move; a position determination device configured to detect the position of the robotic passenger in a building; a communication device configured to communicate with an elevator control device; and the control system for elevator-waiting position of the robotic passenger according to the embodiment of the present disclosure. As described above, the control system for elevator-waiting position of the robotic passenger may include: a detection device, such as a camera device or a lidar sensor, which is configured to detect whether a first-choice elevator-waiting position has been occupied; and a position allocation unit configured to: if the first-choice elevator-waiting position is not occupied, determine the first-choice elevator-waiting position as a target elevator-waiting position; and if the first-choice elevator-waiting position has been occupied, determine a candidate elevator-waiting position as the target elevator-waiting position or issue a prompt so that the person occupying the first-choice elevator-waiting position can make room for the first-choice elevator-waiting position. The detection device may be a detection device possessed by the robotic passenger itself, and the position allocation unit may be integrated in the control device for the robotic passenger. In some embodiments, the control device for the robotic passenger is configured to control the robotic passenger to preferentially move closer to the first-choice elevator-waiting position 31 in at least one elevator-waiting hall when the robotic passenger needs to take the elevator, and detect whether the first-choice elevator-waiting position 31 is occupied; wherein if the first-choice elevator-waiting position 31 is not occupied, the robotic passenger is controlled to move to the first-choice elevator-waiting position 31 to wait for the elevator; and if the first-choice elevator-waiting position 31 has been occupied, the robotic passenger is controlled to move directly to the candidate elevator-waiting position 32, 33 and 34 to wait for the elevator, or a prompt is issued. The robotic passenger according to the embodiment of the present disclosure will not become sluggish or spin around when the elevator-waiting position is occupied, and will not collide with people.

In some embodiments, with the control system for elevator-waiting position of the robotic passenger according to the embodiment of the present disclosure, the control device for the robotic passenger may be configured to: when the first-choice elevator-waiting position 31 is occupied, control the robotic passenger to move close to the first-choice elevator-waiting position 31 and then stop moving, issue a voice prompt, for example, “please move away”, etc., and wait for a specific time, e.g., 1 second to 3 seconds. After the specific time, it is re-detected whether the first-choice elevator-waiting position 31 is occupied; if the first-choice elevator-waiting position 31 is not occupied, the robotic passenger moves to the first-choice elevator-waiting position 31 to wait for the elevator; and if the first-choice elevator-waiting position 31 is still occupied, the robotic passenger moves to the candidate elevator-waiting positions 32, 33 and 34 to wait for the elevator.

In some embodiments, the position allocation unit may include a processor and a memory, and a robotic passenger elevator-taking program is stored in the memory. When the processor executes the robotic passenger elevator-taking program, the robotic passenger is controlled to execute the above described elevator-waiting operations. The memory may also store a map of the building where the robotic passengers are located, and the map includes a plane map of the building and the first-choice and candidate elevator-waiting positions in at least one elevator-waiting hall. The building map may be plotted by the robot passenger itself through its detection device, such as a lidar sensor and/or a camera sensor, and stored in the memory, or downloaded from a server. The first-choice elevator-waiting position or candidate elevator-waiting positions may be obtained through a communication with the elevator control system or obtained from the server. In some embodiments, the robot passenger may use a detection device such as a lidar sensor and/or a camera sensor to detect whether the first-choice elevator-waiting position is occupied. In other embodiments, the robotic passenger may detect whether the first-choice elevator-waiting position 31 is occupied by communicating with the elevator system and using the camera device 4 of the elevator system. In this way, the robotic passenger can know whether the first-choice elevator-waiting position is occupied while the robotic passenger is away from the first-choice elevator-waiting position 31. In some embodiments, the robotic passenger sends an elevator-taking request to the elevator control device through a communication device, and receives information of the assigned elevator from the elevator control device, thereby moving directly to the first-choice elevator-waiting position or the candidate elevator-waiting positions of the assigned elevator.

In another aspect, a control method for elevator-waiting position of a robotic passenger is provided, which includes: detecting whether a first-choice elevator-waiting position has been occupied; if the first-choice elevator-waiting position is not occupied, determining the first-choice elevator-waiting position as a target elevator-waiting position; and if the first-choice elevator-waiting position has been occupied, determining a candidate elevator-waiting position as the target elevator-waiting position or issuing a prompt. The method according to the present disclosure may be implemented as a control method for an elevator system. For example, in some embodiments, as shown in FIG. 2, the method may include: S11. receiving an elevator-taking request signal from a robotic passenger; S12. assigning an elevator that executes the elevator-taking request; and S13. exposing at least one elevator-waiting position corresponding to the assigned elevator in an elevator-waiting hall. With this method, it is possible to, before the robotic passenger takes the elevator, notify the passenger to make room for the elevator-waiting position of the robotic passenger.

In some embodiments, the method may further include: using the camera device 4 in the elevator-waiting hall to determine whether the first-choice elevator-waiting position 31 corresponding to the assigned elevator is occupied; if the first-choice elevator-waiting position 31 is not occupied, determining the first-choice elevator-waiting position 31 as the target elevator-waiting position, and optionally exposing it or notifying it to the robotic passenger; and if the first-choice elevator-waiting position 31 has been occupied, determining at least one of the candidate elevator-waiting positions 32, 33 or 34 as the target elevator-waiting position, exposing it, and notifying the robotic passenger, or issuing a prompt. With such an arrangement, in a case that a passenger occupies the first-choice elevator-waiting position before the robotic passenger, there is no need to request the passenger to move, and the robotic passenger may also directly move to the vacant candidate elevator-waiting position after receiving the notification. As described above, exposing the at least one elevator-waiting position includes changing the illumination and/or color. For example, the projection lamp 2 is used to project at least one elevator-waiting position, or to a lamp embedded in the floor in at least one elevator-waiting position is illuminated.

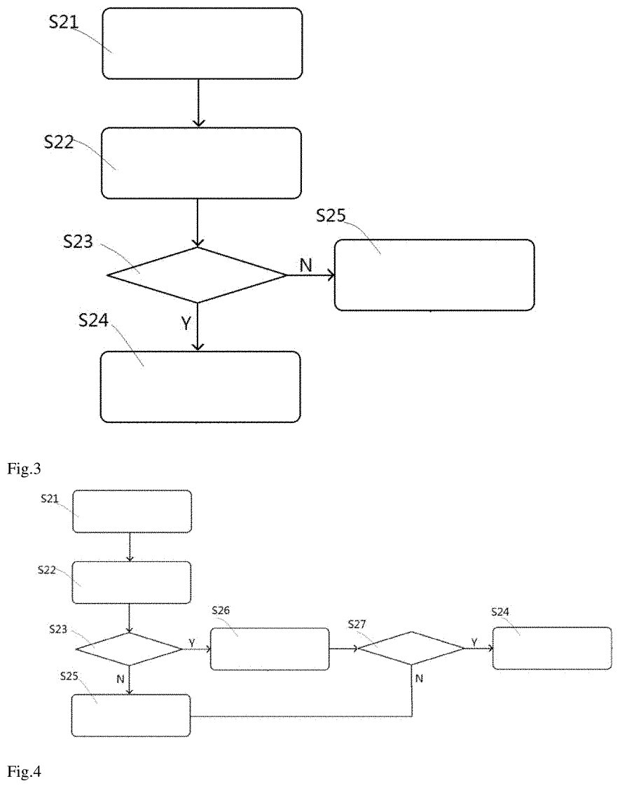

With continued reference to FIG. 3, a flowchart of a control method for elevator-waiting position of a robotic passenger according to the present disclosure is shown. The control method for elevator-waiting position of the robotic passenger according to the embodiment includes: S21. sending an elevator-taking request signal to an elevator control device; S22. receiving information of the assigned elevator from the elevator control device, and moving the robotic passenger close to a first-choice elevator-waiting position corresponding to the assigned elevator in the elevator-waiting hall; S23. detecting whether the first-choice elevator-waiting position is occupied; if the first-choice elevator-waiting position is not occupied, then S25. determining the first-choice elevator-waiting position as the target elevator-waiting position, and moving the robotic passenger to the first-choice elevator-waiting position to wait for the elevator; and if the first-choice elevator-waiting position has been occupied, then S24. determining a candidate elevator-waiting position as the target elevator-waiting position, and moving the robotic passenger to the candidate elevator-waiting position to wait for the elevator. In this embodiment, the robotic passenger will not hinder other passengers and will wait in the candidate position on its own for the elevator.

With continued reference to FIG. 4, in this embodiment, the steps before step S23 are the same as those of the embodiment of FIG. 3. After detecting whether the first-choice elevator-waiting position is occupied in step S23, if the first-choice elevator-waiting position is not occupied, then in S25, the first-choice elevator-waiting position is determined as the target elevator-waiting position, and the robotic passenger moves to the first-choice elevator-waiting position to wait for the elevator; and if the first-choice elevator-waiting position has been occupied, then in S26, the robotic passenger moves near the first-choice elevator-waiting position and then stops moving, issues a voice prompt and waits for a specific time, such as 1 second to 3 seconds. After the specific time, it is re-detected whether the first-choice elevator-waiting position is occupied. If the first-choice elevator-waiting position is not occupied, then in S25, the first-choice elevator-waiting position is determined as the target elevator-waiting position and the robotic passenger moves to the first-choice elevator-waiting position; and if the first-choice elevator-waiting position is still occupied, then in S24, at least one candidate elevator-waiting position is determined as the target elevator-waiting position, and the robotic passenger moves to the at least one candidate elevator-waiting position. In this embodiment, through the interaction between the robotic passenger and other passengers, the other passengers can know about the purpose of the robotic passenger, and make room for the elevator-taking position for the robotic passenger.

The specific embodiments described above are merely for describing the principle of the present disclosure more clearly, and various components are clearly illustrated or depicted to make it easier to understand the principle of the present disclosure. Those skilled in the art can readily make various modifications or changes to the present disclosure without departing from the scope of the present disclosure. Therefore, it should be understood that these modifications or changes should be included within the scope of protection of the present disclosure.

What is claimed is:

1. A control system for elevator-waiting position of a robotic passenger, comprising:
a detection device configured to detect whether a first-choice elevator-waiting position has been occupied; and
a position allocation unit configured to:
if the first-choice elevator-waiting position is not occupied, determine the first-choice elevator-waiting position as a target elevator-waiting position; and
if the first-choice elevator-waiting position has been occupied, determine a candidate elevator-waiting position as the target elevator-waiting position or issue a prompt.

2. The control system for elevator-waiting position of the robotic passenger according to claim 1, wherein the position allocation unit is configured to issue a prompt and wait for a specific time if the first-choice elevator-waiting position has been occupied.

3. The control system for elevator-waiting position of the robotic passenger according to claim 2, wherein after the specific time, the detection device re-detects whether the first-choice elevator-waiting position has been occupied; if the first-choice elevator-waiting position is not occupied, the first-choice elevator-waiting position is determined as the target elevator-waiting position, and if the first-choice elevator-waiting position is still occupied, the candidate elevator-waiting position is determined as the target elevator-waiting position.

4. The control system for elevator-waiting position of the robotic passenger according to claim 1, wherein the control system for elevator-waiting position of the robotic passenger is integrated in the robotic passenger, and the robotic passenger comprises: a robotic passenger body; a mobile device which drives the robotic passenger body to move; a position determination device configured to detect the position of the robotic passenger in a building; and a communication device configured to communicate with an elevator control device.

5. The control system for elevator-waiting position of the robotic passenger according to claim 1, wherein the position allocation unit comprises a memory in which a map is stored, and the map comprises a surrounding scene of at least one elevator-waiting hall, and a first-choice elevator-waiting position and a candidate elevator-waiting position in the at least one elevator-waiting hall.

6. The control system for elevator-waiting position of the robotic passenger according to claim 1, wherein the control system for elevator-waiting position of the robotic passenger is integrated in an elevator control system, and the control system for elevator-waiting position of the robotic passenger further comprises a device that exposes the target elevator-waiting position.

7. The control system for elevator-waiting position of the robotic passenger according to claim 6, wherein said exposing the target elevator-waiting position comprises changing the illumination and/or color of the target elevator-waiting position.

8. The control system for elevator-waiting position of the robotic passenger according to claim 6, wherein the control system for elevator-waiting position of the robotic passenger comprises a projection lamp, from which the target elevator-waiting position is projected.

9. The control system for elevator-waiting position of the robotic passenger according to claim 6, wherein the control system for elevator-waiting position of the robotic passenger comprises at least one ground lamp embedded in the floor, from which the target elevator-waiting position is illuminated.

10. The control system for elevator-waiting position of the robotic passenger according to claim 6, wherein said exposing the target elevator-waiting position comprises exposing a text or logo indication at the at least one elevator-waiting position.

11. A control method for elevator-waiting position of a robotic passenger, comprising:
detecting whether a first-choice elevator-waiting position has been occupied;
if the first-choice elevator-waiting position is not occupied, determining the first-choice elevator-waiting position as a target elevator-waiting position; and
if the first-choice elevator-waiting position has been occupied, determining a candidate elevator-waiting position as the target elevator-waiting position or issuing a prompt.

12. The control method for elevator-waiting position of the robotic passenger according to claim 11, further comprising: issuing a voice prompt and waiting for a specific time if the first-choice elevator-waiting position has been occupied.

13. The control method for elevator-waiting position of the robotic passenger according to claim 12, wherein after the specific time, it is re-detected whether the first-choice elevator-waiting position has been occupied; if the first-choice elevator-waiting position is not occupied, the first-choice elevator-waiting position is determined as the target elevator-waiting position, and if the first-choice elevator-waiting position is still occupied, the candidate elevator-waiting position is determined as the target elevator-waiting position.

14. The control method for elevator-waiting position of the robotic passenger according to claim 11, further comprising controlling the robotic passenger to move to the target elevator-waiting position.

15. The control method for elevator-waiting position of the robotic passenger according to claim 11, further comprising exposing the target elevator-waiting position.

16. The control method for elevator-waiting position of the robotic passenger according to claim 15, wherein said exposing the target elevator-waiting position comprises changing the illumination and/or color of the target elevator-waiting position.

17. The control method for elevator-waiting position of the robotic passenger according to claim 15, wherein said exposing the target elevator-waiting position comprises using a projection lamp to project the target elevator-waiting position.

18. The control method for elevator-waiting position of the robotic passenger according to claim 15, wherein said exposing the target elevator-waiting position comprises illuminating a lamp embedded in the floor at the at least one elevator-waiting position.

19. The control method for elevator-waiting position of the robotic passenger according to claim 15, wherein said exposing the target elevator-waiting position comprises exposing a text or logo indication at the target elevator-waiting position.

20. The control method for elevator-waiting position of the robotic passenger according to claim 11, further comprising assigning a designated elevator based on one or more of robotic passenger information, elevator system information, and building information, and determining the first-choice elevator-waiting position or candidate elevator-waiting position corresponding to the designated elevator as the target elevator-waiting position.
